(19) United States
(12) Patent Application Publication
(10) Pub. No.: US 2026/0027999 A1
(43) Pub. Date: Jan. 29, 2026

(54) System and Method for Power Line Communication (PLC) Reception

(71) Applicant: Bendix Commercial Vehicle Systems LLC, Avon, OH (US)

(72) Inventors: Shawn D. Lammers, Delta (CA); Qing Chen, Coquitlam (CA)

(73) Assignee: Bendix Commercial Vehicle Systems LLC, Avon, OH (US)

(21) Appl. No.: 18/786,182

(22) Filed: Jul. 26, 2024

(51) Int. Cl. B60T 8/17; B60D 1/62; B60T 8/171

(52) U.S. Cl. CPC B60T 8/1708; B60T 8/171; B60D 1/62; B60T 2270/10

(57) ABSTRACT

A system and method for power line communication (PLC) reception are provided. In one embodiment, a tractor controller is provided comprising a main processor, a first co-processor, a second co-processor, and third co-processor. The first co-processor is configured to create a digital waveform from an analog power line communication (PLC) message received from a trailer via a power line. The second co-processor is configured to: for each of a plurality of chirps in the digital waveform, compare a given chirp with a previous chirp to predict whether a phase change occurred; and create a digital bit stream representing the PLC message from the predictions. The third co-processor is configured to process the digital bit stream and send the digital bit stream to the main processor. Other embodiments are provided.

### BACKGROUND

Power line communication (PLC) is a communication method in which data is transmitted over wires that are also used to deliver electric power. The data is encoded within a signal that is transmitted over the wires in frequency ranges outside of those used to transmit electric power. PLC is advantageous relative to other communication methods because it enables communication using existing wiring. Tractor-trailers frequently employ PLC to exchange messages between members of the tractor-trailer including, for example, sensor readings from vehicle systems including anti-lock braking systems, collision avoidance systems, tire pressure monitoring systems, and other vehicle systems, as well as commands used to control anti-lock braking systems, lighting systems, and other vehicle systems.

### BRIEF DESCRIPTION OF THE DRAWINGS

FIG. 1 is a diagram of a vehicle of an embodiment including a plurality of electronic systems communicating along a power line in the vehicle.

FIG. 2 is an illustration of a power line communication (PLC) message of an embodiment.

FIG. 3 is an illustration of a preamble section of a PLC message of an embodiment.

FIG. 4 is an illustration of a data section of a PLC message of an embodiment.

FIG. 5A is a block diagram of an example software-based implementation of an embodiment.

FIG. 5B is a block diagram of a more-detailed block diagram of an example software-based implementation of an embodiment.

FIG. 6 is a flow chart of a method of an embodiment for PLC reception using software algorithms.

### SUMMARY

The following embodiments generally relate to a system and method for power line communication (PLC) reception using software algorithms. In one embodiment, a tractor controller is provided comprising: non-transitory computer-readable storage medium(s) storing first, second, and third sets of instructions, a main processor, a first co-processor, a second co-processor, and third co-processor. The first set of instructions, when executed by the first co-processor, cause the first co-processor to create a digital waveform from an analog power line communication (PLC) message received from a trailer via a power line. The second set of instructions, when executed by the second co-processor, cause the second co-processor to: for each of a plurality of chirps in the digital waveform, compare a given chirp with a previous chirp to predict whether a phase change occurred; and create a digital bit stream representing the PLC message from the predictions. The third set of instructions, when executed by the third co-processor, cause the third co-processor to process the digital bit stream and send the digital bit stream to the main processor.

In another embodiment, a system is provided for use in a tractor configured to communicate with a trailer via a power line. The system comprises at least one processor and non-transitory computer-readable storage medium(s) storing instructions. The instructions, when executed individually or in combination by the at least one processor, cause the at least one processor to: create a digital waveform from an analog power line communication (PLC) message received from the trailer via the power line; predict when phase changes occur in the digital waveform by comparing chirps in the digital waveform; and create a digital bit stream representing the PLC message from the predictions.

In yet another embodiment, a method is provided that is performed in a plurality of processors in a vehicle. The method comprises: creating a digital waveform from an analog power line communication (PLC) message; predicting when phase changes occur in the digital waveform by comparing chirps in the digital waveform; creating a digital bit stream representing the PLC message from the predictions; and sending the digital bit stream to a braking controller in the vehicle.

Other embodiments are possible, and each of the embodiments can be used alone or together in combination.

### DETAILED DESCRIPTION

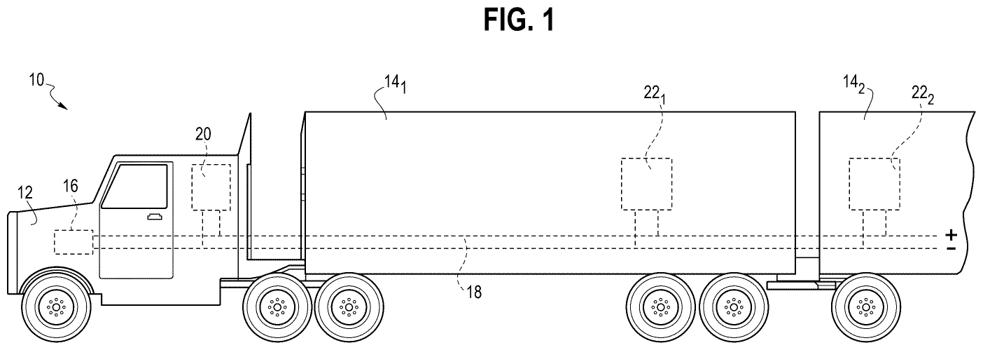

Turning now to the drawings, FIG. 1 illustrates a vehicle of an embodiment; in particular, a tractor-trailer 10. The tractor-trailer 10 (also referred to as a semi) contains a truck or tractor 12 and one or more trailers 141 . . . 14N. In this embodiment, the tractor 12 contains a power unit, such as an internal combustion engine, and steering and drive axles. The tractor 12 also contains a battery 16 for use in starting the power unit and in providing power to various accessory systems. Trailers 141 . . . 14N are provided to store freight and are detachably coupled to the tractor 12. Although a pair of trailers 14 is shown in the illustrated embodiment, it should be understood that fewer or more trailers can be used.

The tractor 12 and the trailers 14 may include various fluid and power lines that extend between the tractor 12 and the trailers 14, including power line 18. The fluid and power lines allow delivery of fluids and electrical power from the tractor 12 to the trailers 14 for use in, for example, tire pressure management, braking, and activation of tail lights on the trailer 14. The power line 18 is also used for power line communication (PLC) to transmit data over wires that are also used to deliver electric power. In PLC, data is encoded within a signal that is transmitted over the wires in frequency ranges outside of those used to transmit electric power. In this example, the power line 18 forms part of a network used to transmit communications between various electronic systems 20, 221 . . . 22N on the tractor 12 and the trailers 14, respectively. Systems 20, 22 may comprise any of a wide variety of systems commonly employed on a tractor-trailer 10 including, for example, anti-lock braking systems, collision avoidance systems, tire pressure monitoring and control systems, trailer load monitoring systems, and lighting systems. The power line 18 may enable transmission of data from one or more systems 22 on the trailers 14 to a system 20 on the tractor 12 including, for example, sensor readings indicative of the operation of an anti-lock braking system, the location of surrounding vehicles and infrastructure, pressure within the tires on the trailer 14, or a shift in the load carried by the trailer 14. The power line 18 may also enable transmission of commands and data from the tractor 12 to the trailers 14 for use in controlling elements of an anti-lock braking system, a tire pressure control system, or a lighting system on one or more of the trailers 14.

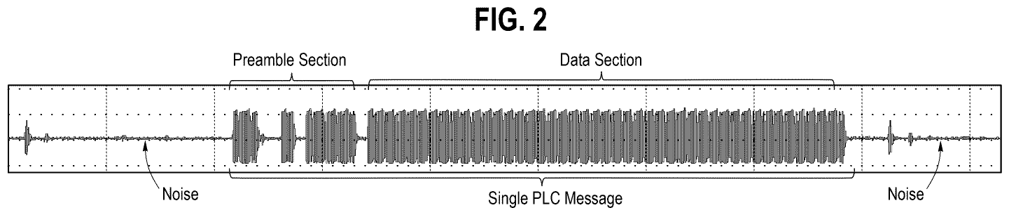

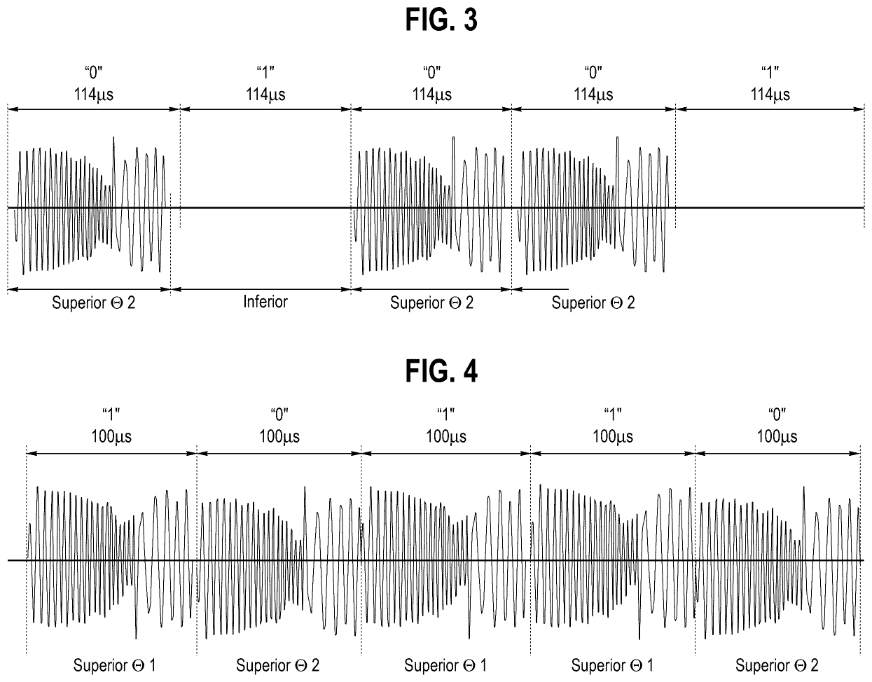

Turning again to the drawings, FIG. 2 is an illustration of a single PLC message of an embodiment. As shown in FIG. 2, this message comprises a preamble section and a data section, examples of which are shown in FIGS. 3 and 4, respectively. As shown in FIG. 3, in the data body, the “0” bit (or SUPERIORΘ2 signal chirp) and the “1” bit (or SUPERIORΘ1 signal chirp) are the same but out-of-phase by 180 degrees. A single SUPERIORΘ1 or SUPERIORΘ2 signal chirp of the preamble and data section is called a “symbol.” In the data section, the length of a symbol is 100 microsecond (us) (plus or minus 0.5%) as per the Society of Automotive Engineers (SAE), as set forth in a document number J2497 and titled “Power Line Carrier Communications for Commercial Vehicles.” Currently, PLC reception following SAE J2497 specification is mandated.

In some vehicles, a hardware circuit is used to detect the start and end of a single PLC message, perform post-processing by identifying the preamble and data sections, and then provide the decoded message to a controller in the tractor 12. For example, a trailer can send a PLC message indicating a problem with that trailer's anti-lock braking system (ABS), and the hardware circuit can decode the PLC message and provide the decoded message (e.g., in an RS232 UART (universal asynchronous receiver/transmitter) format) to the tractor's braking controller, which can illuminate a warning light on the dashboard. In some vehicles, the hardware circuit is an Intellon SSC P485 PL Transceiver IC.

Instead of using a hardware circuit where all of the PLC decoding/encoding functionality is performed in hardware, some or all of that functionality can be performed in software. Providing this functionality in software can be less expensive than providing this functionality only in hardware. Further, by not being dependent on hardware, this embodiment is not dependent on the availability of a specific hardware component from a specific manufacturer.

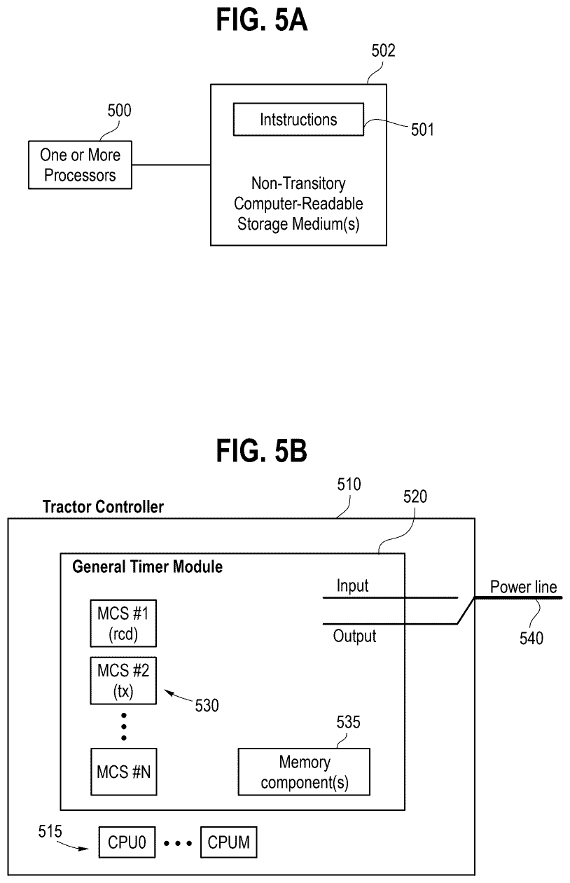

FIG. 5A is a block diagram of an example software-based implementation of an embodiment. As shown in FIG. 5A, one or more processors 500, individually or in combination, can be provided to execute a computer program having computer-readable program instructions 501 to perform the PLC decoding/encoding operations. The instructions 502 can be stored in non-transitory computer-readable storage medium(s) 502.

FIG. 5B is a block diagram of a more-detailed example implementation of an embodiment. In this example, a tractor controller 510 is provided that comprises a plurality of main (e.g., ARM) processors 515 (here, central processing units (CPUs) 0-M) and a general timer module (GTM) 520 coupled with a power line 540. The tractor controller 510 can comprise additional components (e.g., controller area network (CAN) modules, UART modules, etc.) that are not shown to simplify the drawing. Also, different components from those shown can be used. In one example implementation, the tractor controller 510 takes the form of an Infineon AuRIX Tricore Processor.

In this example, one or more of the main processors 515 are configured to perform anti-lock braking system (ABS) and stability control functionality, including, but not limited to, measuring steering angle, yaw, and acceleration and performing braking control needed to make sure the vehicle does not skid. The GTM 520 is used to perform high-accuracy timing calculations and store the results of those calculation in registers, which can be read by the main processors 515. More specifically, the GTM 520 in this example comprises a plurality of multi-channel sequencers (MCS) 530 and one or more memory components 535 (e.g., random access memory (RAM), read-only memory (ROM), a relatively larger non-volatile mass storage memory, etc.). In one embodiment, the MCS 530 only has RAM. The computer program is loaded from the main tri-core Flash and then loaded into a special RAM section dedicated to the MCS 530, and execution runs from this RAM. This RAM can also be accessed by the tri-core ARM processors.

Each MCS can comprise one or more channels, with each channel acting as a separate processor (sometimes referred to herein as a co-processor). The one or more memory components 535 can store computer-readable instructions executable by the one or more co-processors of the MCS 530.

In this embodiment, the co-processors in the GTM 520 are configured to execute software to decode a PLC signal in real time, so that the main processors 515 are not burdened with the decoding operations. After the co-processors of the GTM 520 have decoded and validated the PLC signal, which involves converting the PLC signal from an analog waveform to a digital waveform and then analyzing the digital waveform), the main processors 515 can be woken up and provided with the results. In general, this embodiment takes advantage of the fact that the “0” bit (SUPERIORΘ2 signal chirp or symbol) and the “1” bit (SUPERIORΘ1 signal chirp or symbol) in the data body are the same but out-of-phase 180 degrees. The co-processors in the GTM 520 can digitize the PLC waveform, compare the phase of a given data section with the phase of a previous data section, and provide a simple logic ‘0’ (low) or logic ‘1’ (high) signal to indicate whether the phase of the current and previous data sections is the same or different.

More specifically, in one example implementation, MCS #1, which is used to receive a PLC signal from the power line 540), comprises three threads/co-processors that execute computer-readable code in the memory 535 to decode an analog PLC signal received on the power line 540. (A thread can refer to the smallest sequence of programmed instructions that can be managed independently by a scheduler and is often a component of a process. A first co-processor executes computer-readable code in the memory 535 to convert the analog PLC signal into a digital waveform.

After at least two chirps (e.g., after three chirps) are stored in the memory 535, a second co-processor executes computer-readable code in the memory 535 to compare timing information of a given chirp in the waveform to a previous chirp in the waveform to see if the two chirps are in-phase or out-of-phase. This comparison can be done in parallel with the first co-processor continuing to digitize incoming portions of the PLC signal. A chirp that is out-of-phase indicates that a logical transition occurred. For example, the second co-processor can measure the pulse widths of the positive and negative portions of the waveform that represent 0-to-1 and 1-to-0 logical transitions in the waveform (e.g., for every 100 or 114 microsecond's worth of signal for a message and preamble, respectively).

The second co-processor can do a comparison by performing an exclusive-or (XOR) operation with respect to time to generate a value (e.g., between 0 and 5,000) that represents the difference between the two waveforms. If the value is above a threshold, the value represents a difference in phase/transition in logical state. If the value is below the threshold, the difference can represent jitter or noise. The values for a plurality of chirps are accumulated and stored in the memory 535 by the second co-processor until the PLC message ends. Once the PLC message ends, the memory 535 will have stored therein values that represent state transition of all of the bits in the PLC message. After the end of the message is detected, the third co-processor parses a prediction table storing the values and reconstructs the bit stream (1s and 0s).

After the bit stream is created, a third co-processor executes computer-readable code in the memory 535, creates a message in a UART protocol format and validates the message checksum. On successful UART decode and checksum validation, the third co-processor passes a completion message to the main processors 505. For example, if the PLC message indicates a malfunction in an ABS system of one of the trailers, the main processors 515 can cause an indicator to be presented on the dashboard in the tractor.

So, the GTM 520 in this embodiment can decode the PLC signal from the power line 540 in real time without using a run-time application (and without needed traditional analog-to-digital channels). The software algorithms can use a unique approach to compare subsequent PLC bit patterns to decode the PLC message. The tractor controller 510 can also use same hardware to implement PLC transmission as bus arbitration. In this example, MCS #2 is used to transmit a PLC signal on the power line (e.g., to request vehicle identification numbers (VINs) from the trailers).

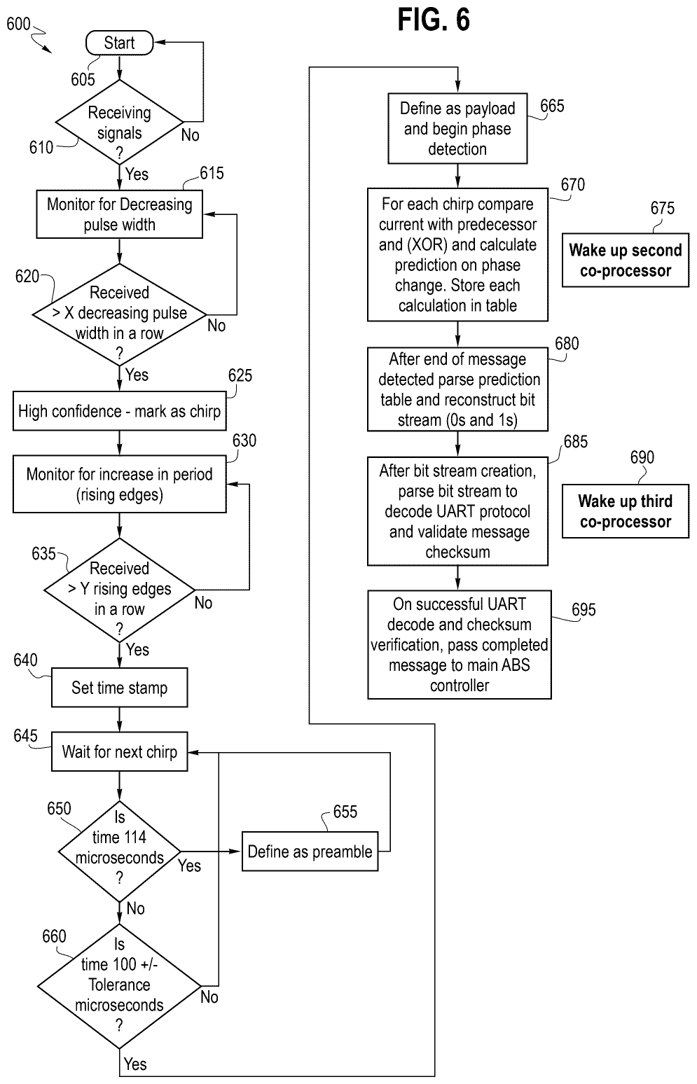

An example software algorithm will now be described in reference to the flow chart 600 in FIG. 6. It should be noted that this is merely an example and that other implementations can be used. As shown in FIG. 6, at the start (605) of the method, the first co-processor determines if signals are received on the power line 540 (610). If no signals are received, the method loops back to 605. If signals are received, the first co-processor monitors for decreasing pulse width (615) and determines whether there is greater than a threshold number (>X) of decreasing pulse widths in a row (620). If there aren't, the method loops back to 615. If there are, the first co-processor marks the signal as a chirp with high confidence (625). The first co-processor then monitors for an increase in period (rising edges) (630) and determines whether there is greater than a threshold number (>Y) of rising edges in a row (635). If there aren't, the method loops back to 630. If there are, the first co-processor sets a time stamp (640).

The first co-processor then waits for a next chirp (645) and determines if a threshold amount of time (e.g., 114 microseconds) has passed (650). If the threshold amount of time has passed, the first co-processor defines the signal as a preamble (655), and the method loops back to 645. If the threshold amount of time has not passed, the first co-processor determines whether the time is within a tolerance (e.g., 100+/−tolerance in microseconds) (660). If it is not, the method loops back to 645. (In one embodiment, multiple chirps with 100 us spacing are required before a conclusion that the chirps are in the data phase.) If it is, the signal is defined as a payload, and phase detection begins (665).

The following is an example process for recreating chirps in memory to be compared by the second processor.

At the start of the data phase:
1. MCS0 stores the current (base) time stamp in a variable.
2. MCS0 sets a variable to indicate edge time stamps should be stored in buffer 1 (buffer pointer).
3. MCS0 waits for a rising edge from the GTM module.
4. MCS0 reads the time stamp and duty cycle from GTM.
5. MCS0 subtracts base time stamp from edge time stamp received from GTM.
6. MCS0 calculates the falling edge time stamp based on the rising edge time stamp and duty cycle.
7. MCS0 appends two entries in the chirp edge buffer. Each entry contains the time stamp of the edge and an indicator whether it is a rising or falling edge.
8. MCS0 continues this process until 100 us has passed. If 100 us has not elapsed go to step 3.
9. If 100 us has elapsed, then MCS0 adds 100 us to the base time stamp, and adds one to the buffer pointer. If buffer pointer is larger than three, it sets the pointer back to 1 (three buffers hold the edges as MCS1 compares two buffers while MCS0 updates the third), then go to step 3.

This continues until a timeout occurs waiting for edges at step 3. This indicates an end of message event.

Then, the data is trapped and decoded.

For each chirp, the second co-processor compares the current signal with the predecessor signal and calculates a prediction on phase change, where each calculation is stored in a table (670), which happens after the second co-processor is woken up (675). After the end of the message is detected, the second co-processor parses the prediction table and reconstructs the bit stream (1s and 0s) (at 680). After the bit stream is created, the third co-processor parses the bit stream to decode a UART protocol and validates the message checksum (685), which is done after the third co-processor is woken up (690). On successful UART decode and checksum validation, the third co-processor passes a completion message to the main ABS controller (e.g., one of the main processors 500) (695).

In summary, the above embodiments provide a way to capture and interpret PLC chirps sent over a PLC network using software instead of using pure hardware. The general timer module (GTM) in the example embodiment is fast enough to allow encoding and decoding of the chirps into messages using software without the need for additional hardware and is fast enough to avoid processing time delays. This fast read can be accomplished by comparing successive chirp waveforms to see if one is the same or different than the last chirp waveform, rather than taking the time to compare to a reference waveform. The waveforms are digitized into rising and falling edges. This embodiment takes advantage of the tight timing of the pulses (e.g., 100 us for a message and 114 us for a preamble) and of the fact that there are only two types of chirps, which are 180 degrees out-of-phase with respect to each other. A chip with a 10 ns resolution can detect a low/high state of a digitized waveform and time-stamp when a transition has occurred. Also, the frequency characteristics of a chirp can be used to determine if a chirp is valid, such that decoding is matter of finding where the preamble ends (e.g., five successive 100 us chirps of the same type) and then recognize the message content by chirp patterns.

It should be understood that all of the embodiments provided in this Detailed Description are merely examples and other implementations can be used. Accordingly, none of the components, architectures, or other details presented herein should be read into the claims unless expressly recited therein. Further, it should be understood that components shown or described as being “coupled with” (or “in communication with”) one another can be directly coupled with (or in communication with) one another or indirectly coupled with (in communication with) one another through one or more components, which may or may not be shown or described herein.

It is intended that the foregoing detailed description be understood as an illustration of selected forms that the invention can take and not as a definition of the invention. It is only the following claims, including all equivalents, which are intended to define the scope of the claimed invention. Accordingly, none of the components, architectures, or other details presented herein should be read into the claims unless expressly recited therein. Finally, it should be noted that any aspect of any of the embodiments described herein can be used alone or in combination with one another.

What is claimed is:

1. A tractor controller comprising:
non-transitory computer-readable storage medium(s) storing first, second, and third sets of instructions;
a main processor;
a first co-processor, wherein the first set of instructions, when executed by the first co-processor, cause the first co-processor to create a digital waveform from an analog power line communication (PLC) message received from a trailer via a power line;
a second co-processor, wherein the second set of instructions, when executed by the second co-processor, cause the second co-processor to:
for each of a plurality of chirps in the digital waveform, compare a given chirp with a previous chirp to predict whether a phase change occurred; and
create a digital bit stream representing the PLC message from the predictions; and
a third co-processor, wherein the third set of instructions, when executed by the third co-processor, cause the third co-processor to process the digital bit stream and send the digital bit stream to the main processor.

2. The tractor controller of claim 1, wherein the first, second, and third co-processors are part of a multi-channel sequencer in a general timer module.

3. The tractor controller of claim 1, wherein the main processor is configured to provide anti-lock brake functionality.

4. The tractor controller of claim 1, wherein the second set of instructions, when executed by the second co-processor, further cause the second co-processor to perform an exclusive-or (XOR) operation to generate a value representing a difference between the given chirp and the previous chirp.

5. The tractor controller of claim 4, wherein the phase change is predicted to occur in response to the value being greater than a threshold.

6. The tractor controller of claim 1, wherein the second set of instructions, when executed by the second co-processor, further cause the second co-processor to store the predictions in a prediction table and create the digital bit stream by reconstructing the digital bit stream from the predictions stored in the prediction table.

7. The tractor controller of claim 1, wherein the third set of instructions, when executed by the third co-processor, further cause the third co-processor to process the digital bit stream by performing a checksum validation.

8. The tractor controller of claim 1, wherein the third set of instructions, when executed by the third co-processor, further cause the third co-processor to process the digital bit stream by performing universal asynchronous receiver/transmitter (UART) decoding.

9. The tractor controller of claim 1, wherein the comparing and creating are performed in parallel.

10. A system for use in a tractor configured to communicate with a trailer via a power line, the system comprising:
at least one processor; and
non-transitory computer-readable storage medium(s) storing instructions that, when executed individually or in combination by the at least one processor, cause the at least one processor to:
create a digital waveform from an analog power line communication (PLC) message received from the trailer via the power line;
predict when phase changes occur in the digital waveform by comparing chirps in the digital waveform; and
create a digital bit stream representing the PLC message from the predictions.

11. The system of claim 10, wherein the instructions, when executed individually or in combination by the at least one processor, further cause the at least one processor to process the digital bit stream and send the digital bit stream to a braking processor of the vehicle.

12. The system of claim 10, wherein the at least one processor comprises at least one co-processor.

13. The system of claim 12, wherein the at least one co-processor is part of a multi-channel sequencer in a general timer module.

14. The system of claim 10, wherein the instructions, when executed individually or in combination by the at least one processor, further cause the at least one processor to perform an exclusive-or (XOR) operation to generate a value representing a difference between a given chirp and a previous chirp.

15. The system of claim 10, wherein the instructions, when executed individually or in combination by the at least one processor, further cause the at least one processor to perform a checksum validation on the digital bit stream.

16. The system of claim 10, wherein the instructions, when executed individually or in combination by the at least one processor, further cause the at least one processor to perform universal asynchronous receiver/transmitter (UART) decoding on the digital bit stream.

17. A method comprising:
performing in a plurality of processors in a vehicle:
creating a digital waveform from an analog power line communication (PLC) message;
predicting when phase changes occur in the digital waveform by comparing chirps in the digital waveform; and
creating a digital bit stream representing the PLC message from the predictions.

18. The method of claim 17, further comprising performing a checksum validation on the digital bit stream.

19. The method of claim 17, further comprising performing universal asynchronous receiver/transmitter (UART) operations on the digital bit stream.

20. The method of claim 17, wherein the plurality of processors comprises a plurality of co-processors in a multi-channel sequencer in a general timer module.
